(19) United States
(12) Patent Application Publication
(10) Pub. No.: US 2007/0094161 A1
(43) Pub. Date: Apr. 26, 2007

(54) Hardware device for genetic algorithms

(75) Inventors: Antonino Calabro, Ficarazzi di Aci Castello (IT); Federico Rivoli, Messina (IT); Fabio Tripodi, Villa San Giovanni (IT)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics S.r.l., Agrate Brianza (MI) (IT)

(21) Appl. No.: 11/190,744

(22) Filed: Jul. 27, 2005

(51) Int. Cl. G06N 3/12

(52) U.S. Cl. 706/13

(57) ABSTRACT

A hardware device is for performing crossover and mutation operations based upon a genetic algorithm. The hardware device may include a random or pseudo-random number generator, and a crossover block, conditioned with a random crossover index, for generating output crossover bit-strings from current bit-strings. The device may also include a mutation block, conditioned with a random mutation index, for generating output bit-strings by switching at least one bit of each input bit-string pointed to by the mutation index. A memory may temporarily store the current bit-strings and the output bit-strings. In addition, the hardware device may include a control unit, interfaced with the random number generator, the crossover block, the mutation block and the memory and managing their functioning by generating respective control signals therefor.

### FIELD OF THE INVENTION

This invention relates to a hardware device for performing via hardware the crossover and mutation operations of a genetic algorithm over a set of bit-strings representing the “population” of “individuals” to be processed.

### BACKGROUND OF THE INVENTION

Genetic algorithms (or, more briefly, GAs) are global search and optimization algorithms based on the principles of natural selection. The GAs operate on a set (a “population”) of “individuals”, generally composed of strings of bits, and generate a new “population of individuals” by performing the operations of selection, crossover and mutation on the current “population”.

The steps of a genetic algorithm are now briefly illustrated referring to a practical case, for better clarifying the field of this invention.

Let us consider the problem of maximizing the output of a device by switching an array of five input switches. For each configuration “s” of the switches, the device generates a certain output signal F(s). The objective to be reached includes finding a configuration of switches for which the output signal is maximized.

This optimization problem may be solved with a genetic algorithm by encoding each configuration with a string of five bits, wherein an active bit (1) represents a switch in a conduction state, while a null bit (0) represents an off switch. For example, the bit-string 11110 represents a configuration in which four switches of the array are on, while the fifth switch is off.

The first step includes choosing an initial “population” of “individuals”, that is an initial set of bit-strings, such as for instance the set composed of the following bit strings:

| | | | |
|---|---|---|---|
| 01101 | 11000 | 01000 | 10011 |

As an alternative, the individuals may be integer numbers ranging from 0 to 31 corresponding to strings of five bits.

It is worth noticing that a set of independent variables can be encoded in a bit-string, even if they are not binary, by encoding each variable with a corresponding bit-string and merging all the bit-strings of the parameters in a single bit-string, as schematically shown in FIG. 1. If the variables assume fractional values, they may be represented with a bit-string containing a sign-bit, bits representing the integer part and bits representing the decimal part of the value of the variable.

Starting from a “population”, for each “individual” a fitness value is calculated, that determining the probability of reproducing the same “individual” in the next generation. In practice, “individuals” with a larger fitness value have a larger probability of being present in the next “population”.

Let us suppose that the fitness function be given by the following equation:
F(s)=s²

Therefore, the four above mentioned bit strings are associated to the following fitness values and probabilities:

| String | Fitness | Probability |
|---|---|---|
| 01101 | 169 | 14.4% |
| 11000 | 576 | 49.2% |
| 01000 | 64 | 5.5% |
| 10011 | 361 | 30.9% |

Once a new group of individuals is generated according to the above probabilities, the new strings are generated with the crossover operation. In practice, two “sons” bit-strings are generated by exchanging a random portion of two “parents” bit-strings. This is done as illustrated in the following table:

| “Parent” strings | “Son” strings |
|---|---|
| 110\|00 | 11011 |
| 100\|11 | 10000 |

In the above case the two least significant bits are exchanged, but it is possible to exchange any number of bits, such as the least and the most significant bits, or the first two (or even more than two) most significant bits, and so on.

A new “population” is obtained by applying the mutation operator over the set of “son” strings. The mutation operator may change randomly any bit of any “son” string with a certain probability.

This last operator is important because, using only the crossover and the selection operators, there could be bit-strings that would never be generated. A too large mutation probability could make the genetic algorithm never converge towards a solution, while a too small mutation probability could make the GA converge to local minima (or maxima) and not to global minima (maxima).

The fitness values for individuals of the generated population are calculated and, if a stop condition is verified, the algorithm is stopped and a result is output.

FIG. 2 shows the steps of a classic genetic algorithm.

Genetic algorithms are very powerful tools for controlling the evolution of systems, especially of systems the time evolution of which cannot be formulated analytically. Indeed, the main advantage in using genetic algorithms is that it is not necessary to know analytical formulas describing the evolution of a system for implementing them.

Typically, genetic algorithms are performed using a software executed by a computer. Unfortunately, for complex systems it is necessary to carry out many operations for implementing a control method based on GAs. As a consequence, software implemented control methods based upon GAs are relatively slow and cannot be used for controlling systems evolving with relatively fast dynamics.

U.S. Pat. No. 5,971,579 discloses a method for determining gains of a PID (Proportional, Integral, Differential) controller using a specifically designed genetic algorithm. The unit disclosed therein uses a Random Number Generator including an analog amplifier for amplifying an input noise and of a block that converts the amplitude of the noise in a corresponding bit-string.

### SUMMARY OF THE INVENTION

The present invention is directed to a hardware device for performing the crossover and mutation operations of any genetic algorithm at an outstandingly high speed. The device preferably comprises programmable logic gates, that generate a result much faster than a microprocessor running software.

The hardware device receives input bit-strings representing “individuals” of a “population” to be processed and the multiplicity of each “individual” in the “population”. Then it obtains an initial population to be processed by storing in an internal memory as many replicas of the bit-string representing a same individual as the multiplicity thereof. The crossover and mutation operators are applied to these bit-strings representing the initial “population” for generating a new set of bit-strings representing a new “population of individuals”.

The bit-strings of the generated “population” are transmitted to an external fitness calculation system that calculates the fitness value associated to each “individual” and the multiplicity thereof in the next “population”.

In practice, the selection operation is in part performed by this external system, which calculates the fitness of each individual and calculates the multiplicity thereof, and in part by the hardware device, that generates an initial “population” by replicating each “individual” by the multiplicity thereof.

Preferably, the external fitness calculation system is a personal computer (PC) that executes a software code.

### BRIEF DESCRIPTION OF THE DRAWINGS

The invention is described referring to the attached drawings, wherein:

FIG. 1 shows how to encode the values of n independent variables with a single bit-string as in the prior art;

FIG. 2 is a flow chart of a genetic algorithm as in the prior art;

FIG. 3 is a block diagram of the hardware device of this invention for optimizing the values of a PID regulator;

FIG. 4 shows the ports of the hardware device of this invention;

FIG. 5 shows the parallel interface of the hardware device of this invention;

FIG. 6 is a timing diagram of the control flag and the status flag of the parallel interface of this invention;

FIG. 7 depicts the tristate output buffer for connecting the parallel interface to an external PC of this invention;

FIGS. 8 and 9 are state diagrams that illustrate the functioning of the parallel interface of this invention;

FIG. 10 shows the organization of the DPRAM of this invention;

FIG. 11 shows the DPRAM block of the hardware device of this invention;

FIG. 12 depicts the random number generator of the hardware device of this invention;

FIGS. 13a to 13c depict the set of states reached by the random number generator of FIG. 12 for three different settings of its parameters of this invention;

FIG. 14 depicts the crossover block of the hardware device of this invention;

FIG. 15 illustrates the crossover operation of this invention;

FIG. 16 is a state diagram that illustrate the functioning of the crossover block of this invention;

FIG. 17 depicts the mutation block of the hardware device of this invention;

FIG. 18 illustrates the mutation operation of this invention;

FIG. 19 is a state diagram that illustrate the functioning of the mutation block of this invention;

FIG. 20 depicts the control block of the hardware device of this invention; and

FIGS. 21 to 24 are state diagrams that illustrate the functioning of the control block of this invention.

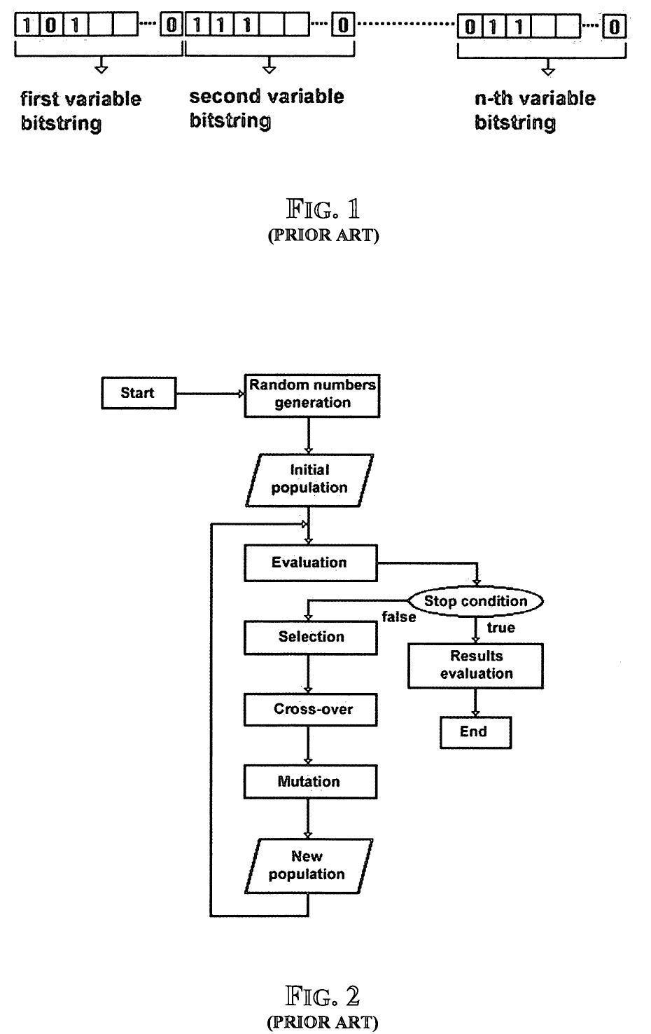

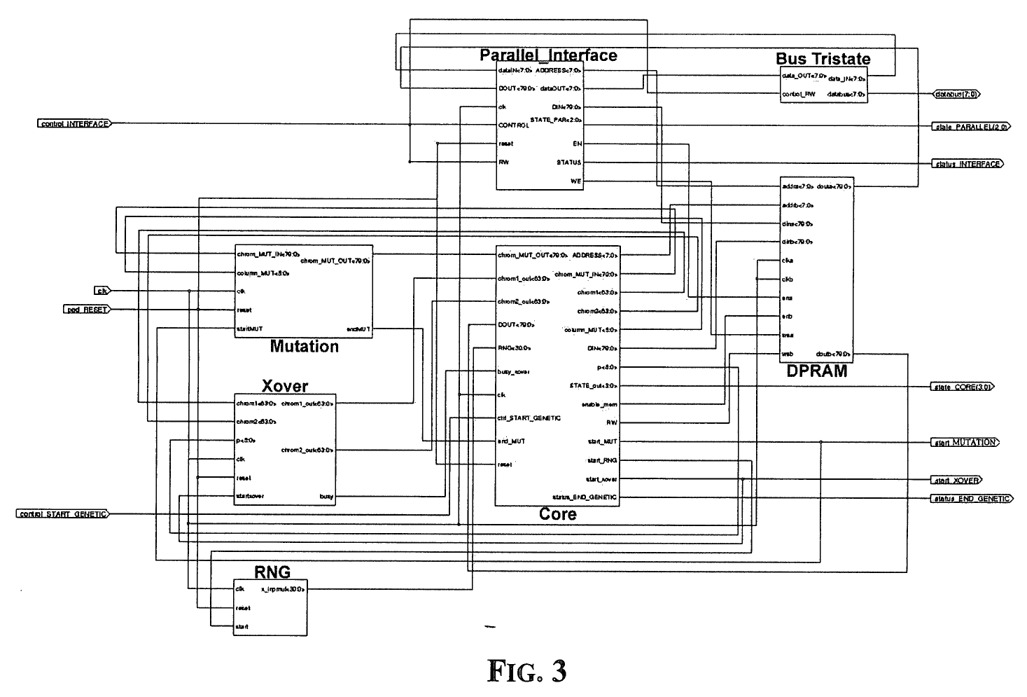

### DETAILED DESCRIPTION OF THE PREFERRED EMBODIMENTS

The hardware device of this invention for carrying out genetic algorithms will be described supposing that the variables to be optimized are four, such as the parameters of a PID regulator. Further, it is supposed that each “population” includes only 128 “individuals”, each identified by 8 bytes. Obviously, what will be stated hereinafter holds, mutatis mutandis, also if there are more than four variables to be controlled, or if there are more than 128 “individuals” in each “population”, or if each bit-strings includes more than 8 bytes.

A scheme of the hardware device of this invention that carries out a genetic algorithm for optimizing the values of the four parameters of a PID regulator is shown in FIG. 3.

This hardware is interfaced with an external fitness calculation system, which is typically a Personal Computer (PC), that calculates the fitness value of each “individual” and its multiplicity. Then the PC transmits each individual with its multiplicity to the hardware device.

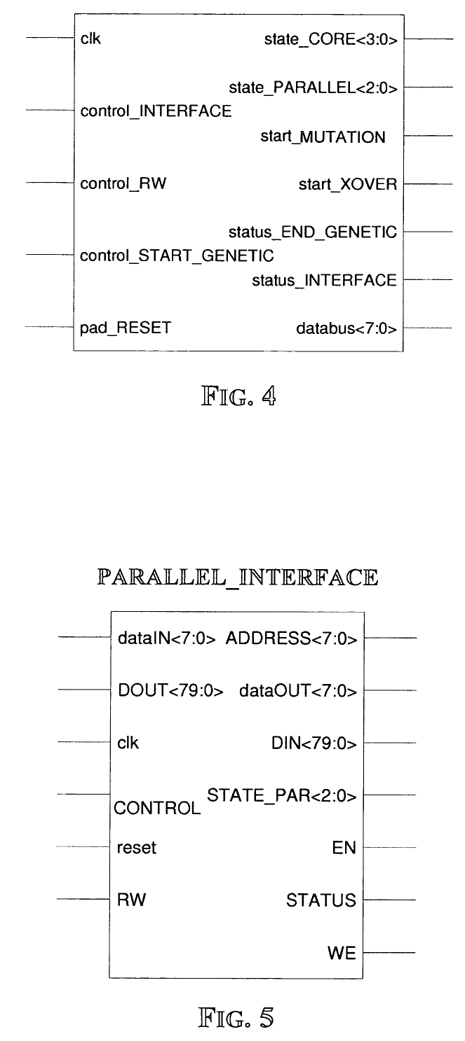

FIG. 4 depicts the input/output ports of the device of the invention. The meaning of its inputs and outputs is shown in the following table:

| clk | Clock signal |
|---|---|
| control_INTERFACE | Start signal for the block |
| | PARALLEL_INTERFACE coming from |
| | the external fitness calculation |
| | system (PC) |
| control_RW | Read/Write signal coming from |
| | the external fitness calculation |
| | system (PC) in order to |
| | read/write the DPRAM via the |
| | block PARALLEL_INTERFACE |
| control_START_GENETIC | Start signal for the block CORE |
| | coming from the external fitness |
| | calculation system (PC) |
| pad_RESET | Asynchronous reset for the whole |
| | architecture |
| state_CORE<3:0> | Signal representing the internal |
| | state of the block CORE |
| state_PARALLEL<2:0> | Signal representing the internal |
| | state of the block |
| | PARALLEL_INTERFACE |
| start_MUTATION | Output signal corresponding to |
| | the start signal given to the |
| | MUTATION block by the CORE block |
| start_XOVER | Output signal corresponding to |
| | an external image of the start |
| | signal given to the XOVER block |
| | by the CORE block |
| status_END_GENETIC | Logic flag that signals when the |
| | block CORE is in the END state |
| status_INTERFACE | Signal representing the state of |
| | the block PARALLEL_INTERFACE |
| databus<7:0> | Data bus connecting the external |
| | fitness calculation system (PC) |
| | and the device of the invention |

Parallel_Interface

This block is a parallel interface for connecting the hardware device with the external system that calculates the fitness values (PC). It receives 80 bits words—each representing an “individual” with its multiplicity—sent by the fitness calculation system preferably byte per byte, through a parallel port, and that are successively stored in the DPRAM. The interface is shown in FIG. 4 and its input and output signals are listed in the following table:

| clk | Clock signal |
|---|---|
| STATUS | Status flag of the block PARALLEL_INTERFACE |
| RESET | Reset signal |
| WE | Write enable to the DPRAM |
| CONTROL | Control flag |
| RW | Flag determining the read/write operation to be |
| | performed |
| EN | Flag that starts the operation indicated by the |
| | RW flag |
| DIN (79:0) | DPRAM input data bus of bit-strings representing |
| | “individuals” and their multiplicity |
| dataIN (7:0) | Input data byte coming from the PC to be written |
| | inside the DPRAM. It is a part of the bit-string |
| | representing a single individual. |
| dataOUT (7:0) | Output data byte from the DPRAM to the PC. It |
| | represents a single byte of the bit-string of the |
| | individual. |
| DOUT (79:0) | Output bus of bit-strings representing |
| | “individuals” and their multiplicity |
| ADDRESS | Address of the DPRAM where individuals are |
| | written or read. |
| STATE_PAR<2:0> | Signal representing the internal state of the |
| | block PARALLEL_INTERFACE |

The fitness calculation system sends to the hardware architecture a certain number of “individuals”, the number of copies of each of them and the respective fitness value. The parallel interface shown in FIG. 5 is designed for receiving 128 “individuals” of 64 bits each and the number of copies (multiplicity) of a same “individual” is represented by a 16 bit-string merged with the bit-string representing the “individual”. This bit-string of 80 bits, received from the PC preferably byte per byte through the dataIN(7:0) bus, is sent to the DPRAM through the input DIN(79:0).

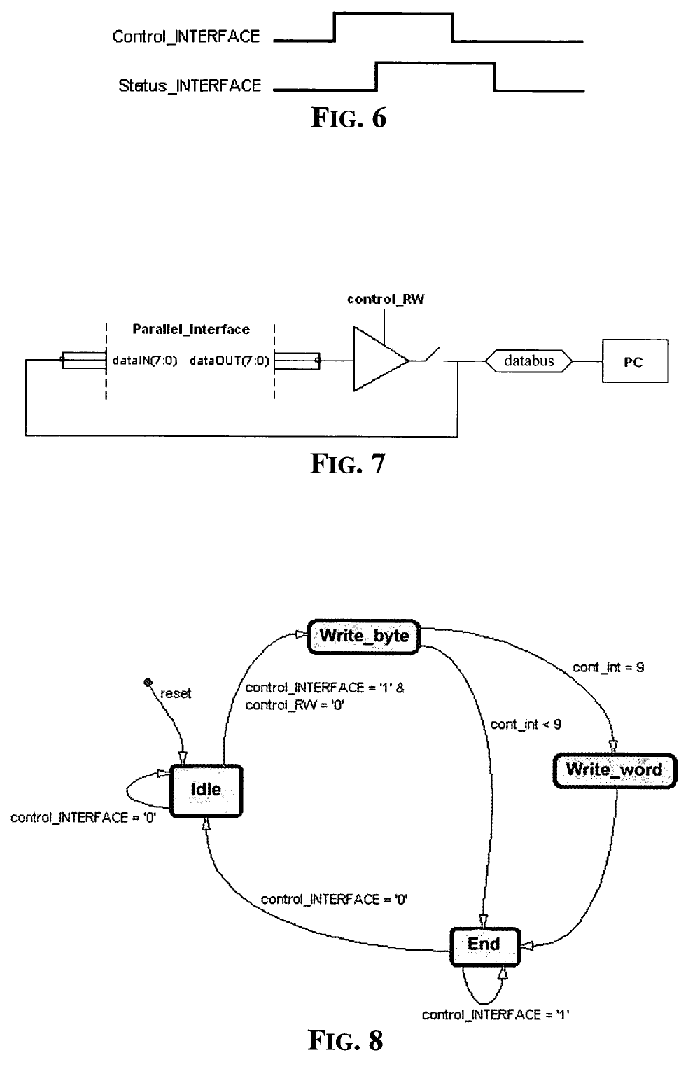

When data are sent to or from the interface, a control flag control_INTERFACE is switched active, as shown in FIG. 6, and a second flag RW specifies whether data are to be read from the bus DIN or sent to the bus DOUT.

Let us suppose that data are to be sent from the fitness calculation system to the hardware architecture of this invention. One byte of data is sent on the bus dataIN(7:0), then the flag control_INTERFACE switches high and the flag RW switches null for signaling that data are being read from the fitness calculation system. When the hardware acquires the byte, the flag status_INTERFACE switches high and for acknowledging that a byte has been read.

When the fitness calculation system receives a logically high flag status_INTERFACE, it switches low the flag control_INTERFACE and sends another byte on the bus DIN(7:0). In the meanwhile, the hardware architecture of this invention switches low the flag status_INTERFACE and is ready to read another byte.

The same procedure takes place when data are being sent from the hardware to the fitness calculation system.

According to a preferred embodiment, the parallel interface communicates with the fitness calculation system through a tristate output buffer, such as the one shown in FIG. 7, for preventing undesired signals from being sent to the fitness calculation system, that in the mentioned figure is a PC. The flag RW forces the buffer in a tristate state or not. Evidently, when data are being sent to the hardware architecture, the output buffer is set into the tristate state.

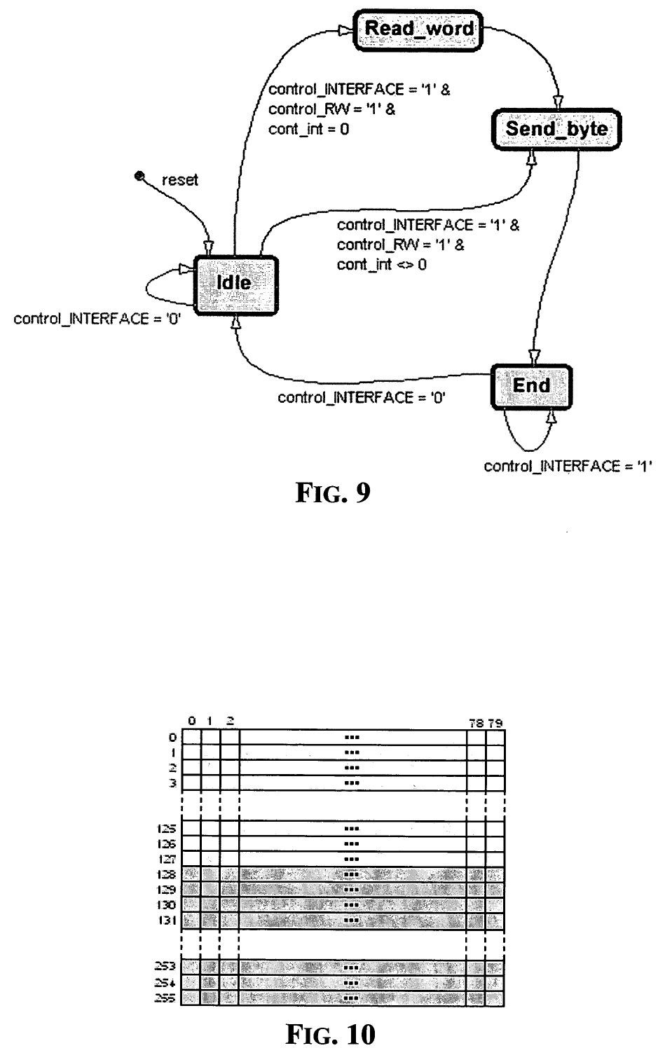

A block diagram that describes the functioning of the finite state machine, that receives data from the fitness calculation system (PC), is shown in FIG. 8.

As far as the flag control_INTERFACE is logically null, the finite state machine remains idle. When this flag switches high and the flag RW is null (control_INTERFACE=‘1’ & control_RW=‘0’), one byte at the time is written in the bus DATABUS.

When a byte is in the bus DATABUS, the flag STATUS is switched high, thus the byte is received by the parallel interface, which terminates the reading of the byte (END), and the PC sends a successive byte. In the meanwhile the flag control_INTERFACE switches low and the interface remains in the state IDLE as long as a new byte is on the bus DATABUS.

The bytes transferred through the bus DATABUS are counted (CONT_{—}INT) by a register (not shown). When the counting CONT_{—}INT equals nine, a full bit-string of an “individual” (ten bytes) has been sent to the interface. This bit-string, stored in internal latches of the interface, is sent (WRITE_{—}WORD) to the internal memory DPRAM of the hardware architecture through the bus DOUT(79:0), and the address at which this bit-string is to be stored is transmitted through the bus ADDRESS(7:0).

When the flag status_INTERFACE switches low again, the bits of another “individual” are sent to the interface.

A block diagram that illustrates the sequence of steps to be performed for transferring a bit-string from the interface to the external fitness calculation system (PC) is shown in FIG. 9.

A full bit-string (80 bits in the considered case) of an “individual” is read (READ_{—}WORD) from the internal DPRAM memory of the hardware architecture when the flag RW is logically active (RW=‘1’) and the flag control_INTERFACE switches active. When the bit-string read from the memory is stored in a temporary memory of the interface, it is sent one byte at the time (SEND_{—}BYTE) in correspondence of each leading edge of the flag control_INTERFACE.

Evidently, the parallel interface may assume one of six states, namely IDLE, WRITE_{—}BYTE, WRITE_{—}WORD, READ_{—}WORD, SEND_{—}BYTE, END. Therefore, the state of the interface may be encoded with a three-bit-string STATE_PAR<2:0>.

DPRAM

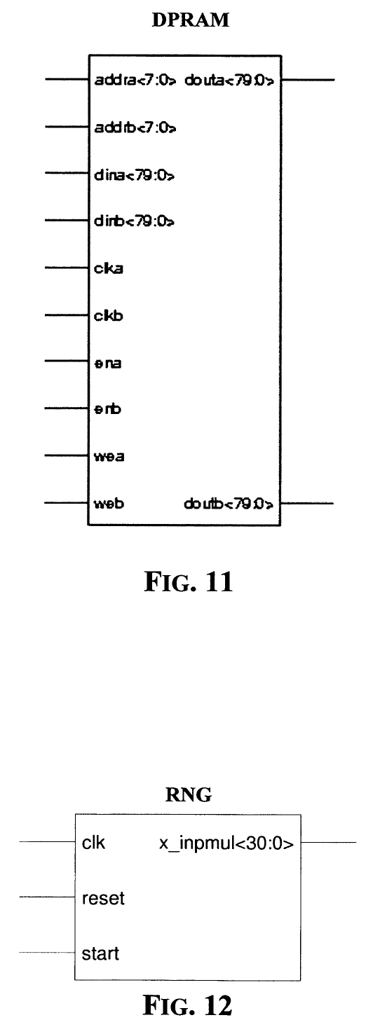

The internal memory of the hardware architecture is preferably organized as shown in FIG. 10. It includes a number of rows that is twice the number of “individuals”, each row having 80 bits for storing a bit-string representing an “individual”. The addresses at which “individuals” to be transmitted to the external PC are stored are from 128 to 255. In practice, bit-strings coming from the PC are written at addresses from 0 to 127, while individuals generated by the hardware architecture of this invention are stored at addresses from 128 to 255.

The DPRAM (Dual Port RAM) is depicted in FIG. 11 and the meaning of its inputs and outputs is resumed in the following table:

| | |
|---|---|
| dina<79:0> | Data to be written in the dual port memory via port A |
| dinb<79:0> | Data to be written in the dual port memory via port B |
| addra<7:0> | The memory location to which data are to be written |
| | or read via port A |
| addrb<7:0> | The memory location to which data are to be written |
| | or read via port B |
| wea | Control signal used to allow the transfer of data in |
| | the dual port memory via port A |
| ena | Control signal used to enable memory accesses from |
| | port A |
| enb | Control signal used to enable memory accesses from |
| | port B |
| clka | Clock input for side A of the dual port memory |
| clkb | Clock input side B of the dual port memory |
| douta<79:0> | Data output side A of the dual port memory |
| doutb <79:0> | Data output side B of the dual port memory |
| web | Control signal used to allow the transfer of data in |
| | the dual port memory via port B |

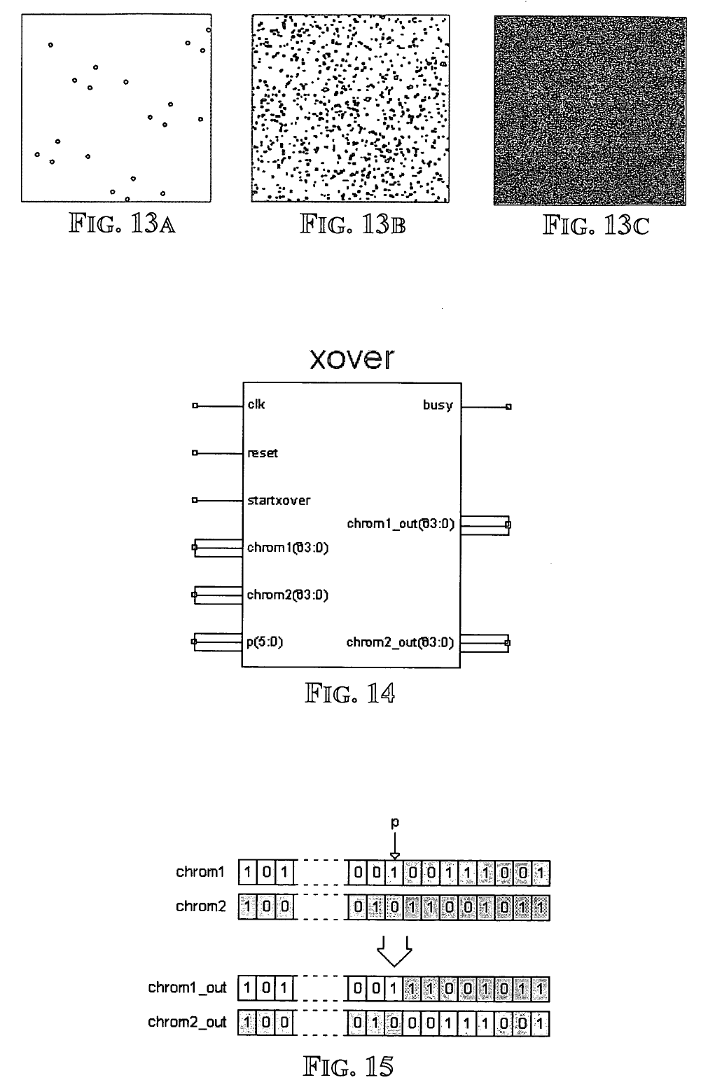

The block RNG, shown in FIG. 12, is a generator of a pseudo-random bit-strings. Its inputs and outputs signals are listed in the following table:

| clk | clock signal |
|---|---|
| reset | logic signal for resetting the counting |
| start | logic signal for starting the counting |
| x_inpmul<30:0> | bit-string representing the generated random |
| | value xₙ |

The output of this block is a random variable that is used for choosing the number of bits of “individuals” that are involved in the crossover operation, the pair of individuals for performing the crossover operation, for choosing the bit (or bits) of “individuals” that will be subject to the mutation operation and the probability with which this bit (or bits) is to be inverted.

Many pseudo-random bit generators use the following recursive formula:
xₙ₊₁=(A₁xₙ+A₂)mod N (1)
wherein A₁, A₂ and N are pre-established parameters fixed by the user, together with the seed x₀ of the sequence, xₙ is the present output and xₙ+1 is the next output. For instance, if x₀=79, A₁=273, A₂=71 and N=100, the “present value—next value” map depicted in FIG. 13a is obtained, while for x₀=1, A₁=16807, A₂=0 and N=2147483647 the “present value—next value” map of FIG. 13b is obtained.

Evidently, the maps represented in FIGS. 13a and 13b can hardly be termed random, because only too few different output values may be generated.

It has been noticed that, by using the same parameters A₁, A₂, N of the map of FIG. 13b but with three different seeds X₀=1, x₀=2 and x₀=3, the map of FIG. 13c is obtained. Therefore, using equation (1) but changing the seed after a certain number of iterations, allows the generation of many more values. The map of FIG. 13c is deterministic, that is all the values represented therein may be analytically calculated, but it looks like a map generated by a truly random number generator.

According to an aspect of the invention, a sequence of pseudo-random numbers is generated by using the recursive formula (1) and by changing the seed of the sequence when a certain number of iterations have been carried out.

According to an embodiment, the seed of each pseudo-random sequence may be generated with a Free Running Timer (FRT), which may be a 31 bit counter (if the number N equals 2147483647).

The value of A₁ is 16807 and it is encoded with a bit-string of 15 bits. At most 31 bits are needed for encoding a value xₙ, because N=2147483647. Therefore, the result of the multiplication A₁xₙ modulo N is simply obtained by considering only the 31 least significant bits of the multiplication A₁xₙ.

The number of selected bits of output random bit-strings RNG is seven when a random address is to be generated, while it is six when random crossover or mutation indexes (defined hereinafter) are to be generated.

Preferably, not the same group of bits of the generated random bit-strings are considered for obtaining the random addresses and random indexes. For this reason, the block RNG includes a logic circuit (not depicted) that selects from time to time a different group bits of interest, preferably according to a circular order. This means that, for example, a first random address could be provided by the 7 least significant bits, then a second address could include the bits from the eighth least significant to the bit before the last significant bit, and so on as far as the seven most significant bits are selected. Then the successive address could include the least significant bit followed by the six most significant bits, and so on.

XOVER

The crossover block XOVER, shown in FIG. 14, implements the crossover operation of two individuals chrom1(63:0) and chrom2(63:0). Its inputs and outputs are listed in the following table:

| clk | Clock signal |
|---|---|
| busy | Flag active when the block is not in the IDLE state |
| reset | Command for resetting the output bit-strings |
| startxover | Flag switched active for starting the crossover |
| chrom1_out(63:0) | Output bit-strings of a first “individual” |
| chrom1(63:0) | Input bit-strings of a first “individual” |
| chrom2(63:0) | Input bit-strings of a second “individual” |
| P(5:0) | Crossover index |
| chrom2_out(63:0) | Output bit-strings of a second “individual” |

The crossover index P(5:0) indicates the group of bits to be exchanged between two “parent” bit strings. In practice, according to the preferred embodiment, only a group of least significant bits are exchanged, and P is the pointer to the most significant bit of this group of bits.

The group of bits of the “individuals” to which the crossover is to be performed are randomly determined by the RNG block, and are provided to the circuit block CORE. The crossover operation is schematically exemplified in FIG. 15.

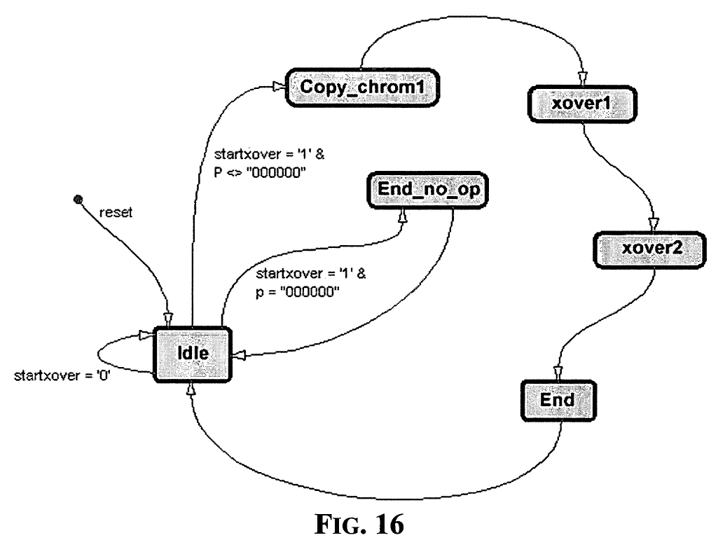

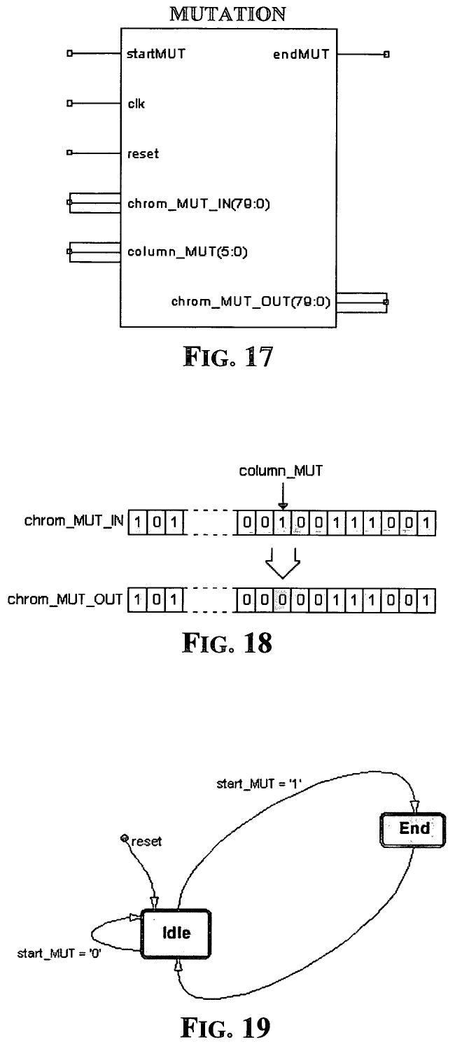

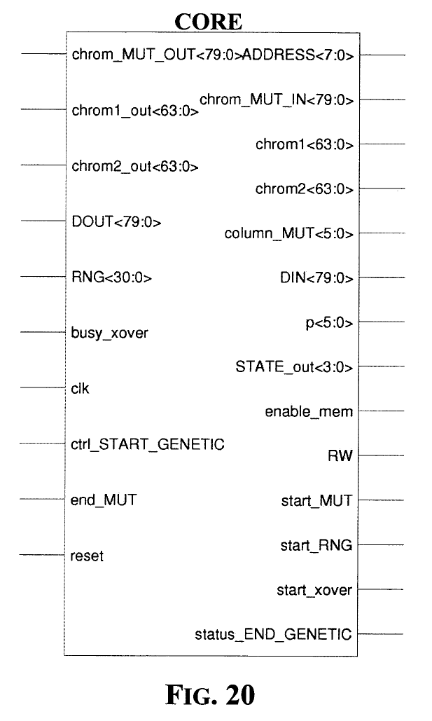

The flag STARTXOVER starts the crossover operation between two input bit-strings of “individuals” chrom1(63:0) and chrom2(63:0), and generates two output bit-strings chrom1_out(63:0) and chrom2_out(63:0) according to the block diagram of FIG. 16.

More in detail, the crossover operation starts in correspondence with the leading edge of the flag STARTXOVER, and the block XOVER switches to high the flag BUSY. If the crossover index P is null, this means that the output “individuals” are identical to the input “individuals” and so no crossover operation is performed (END_{—}NO_{—}OP).

By contrast, if P is non null, the following steps are performed:

the whole input bit-string chroml(63:0) is copied into a temporary register of the crossover block (state COPY_{—}CHROM1);

all bits from P-1 down to 0 of the input bit-string chrom2(63:0) are written in order in the temporary register over the previously stored bits for generating the first output bit-string chrom1_out(63:0) (operation XOVER1);

all bits from 63 down to P of the input bit-string chrom1(63:0) are written in order in the temporary register over the previously stored bits for generating the second output bit-string chrom2_out(63:0) (operation XOVER2); and

when the operation XOVER2 is ended (state END), the block XOVER returns in the state IDLE and the flag BUSY switches low.

Mutation

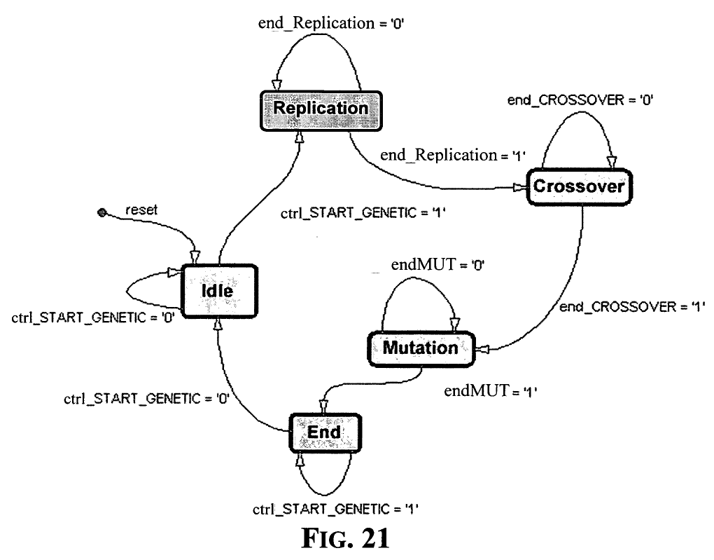

The block MUTATION depicted in FIG. 17 carries out the mutation operation of a genetic algorithm. Its input and output signals are listed in the following table:

| | |
|---|---|
| startMUT | Command that starts the mutation operation |
| endMUT | Flag that signals the end of the mutation |
| | operation |
| clk | Clock signal |
| reset | Command for resetting the output |
| chrom_MUT_IN(79:0) | Input bit-string to be processed |
| column_MUT(5:0) | Pointer to the position of the bit of the |
| | input bit-string to be mutated (mutation |
| | index) |
| chrom_MUT_OUT(79:0) | Output bit-string representing a mutated |
| | “individual” |

The output bit-string chrom_MUT_OUT is generated by switching a bit, of the input bit-string chrom_MUT_IN, the position of which is pointed to by the mutation index column_MUT (generated by the block RNG) according to the scheme of FIG. 18.

The functioning of the block MUTATION is illustrated in FIG. 19. When the command startMUT switches high, an output bit-string is generated by switching the bit of the input bit-string pointed by the string column_MUT(5:0), then the block returns in an idle state IDLE by switching high the flag endMUT that signals that the mutation operation has been carried out.

CORE

The control block CORE manages all other circuit blocks included in the hardware architecture of the illustrated embodiment. It is shown in FIG. 20 and its input and output signals are listed in the following table:

| | |
|---|---|
| enable_mem | Enables the DPRAM memory |
| ctrl_START_GENETIC | Input coming from the PC that |
| | starts the block CORE |
| RW | Read/write signal |
| busy_xover | Flag that signals the end of the |
| | crossover phase |
| status_END_GENETIC | Flag that signals the end of all |
| | the calculations |
| end_MUT | Flag that signals the end of the |
| | mutation |
| start_RNG | Signal to give the start signal |
| | to random number generation |
| clk | Clock signal |
| start_xover | Command that starts the crossover |
| reset | Reset signal |
| start_MUT | Command that starts the mutation |
| chrom_MUT_OUT<79:0> | Bit-string representing a mutated |
| | “individual” |
| DIN<79:0> | Data input coming from the parallel |
| | interface to be sent to the DPRAM |
| DOUT<79:0> | Data output from the DPRAM to be |
| | sent to the block |
| | PARALLEL_INTERFACE |
| ADDRESS<7:0> | Address coming from the |
| | PARALLEL_INTERFACE that indicates |
| | the source/destination DPRAM |
| | location |
| RNG<30:0> | Random number provided by the |
| | RNG module |
| chrom1<63:0> | Bit-string of a first input |
| | “individual” |
| chrom1_out<63:0> | Bit-string of a first output |
| | “individual” |
| chrom2<63:0> | Bit-string of a second input |
| | “individual” |
| chrom2_out<63:0> | Bit-string of a second output |
| | “individual” |
| P<5:0> | Crossover index |
| chrom_MUT_IN<79:0> | Input bit-string to be processed |
| column_MUT<5:0> | Pointer to the position of the bit |
| | of the input bit-string to be |
| | mutated (mutation index) |
| STATE_out<3:0> | Signal representing the internal |
| | status of the block CORE |

This control block is substantially a state machine that performs the operations illustrated in the flow charts of FIGS. 21 to 24. As shown in FIG. 21, the control block manages the execution in sequence of the replication, crossover and mutation operations.

The first operation to be performed by the control block CORE is the selection operation, that is started by switching active the command ctrl_START_GENETIC.

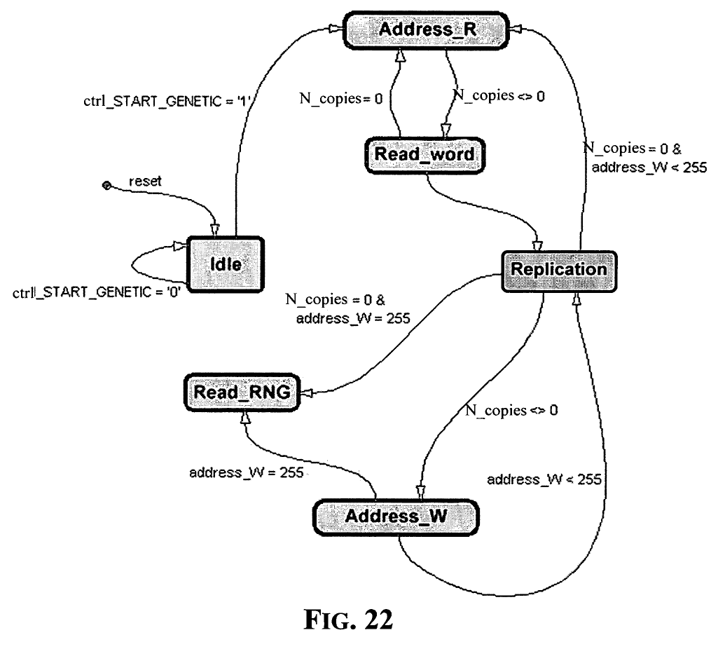

The steps to be carried out for managing the execution of the selection operation are shown in FIG. 22. When the command ctrl_START_GENETIC switches active, the control block CORE leaves an idle state IDLE and enters the state ADDRESS_R, starts the random number generator RNG and switches active the flag status_END_GENETIC for signaling to the external fitness calculation system (PC) that the hardware is carrying out the steps of a genetic algorithm for generating a new population of “individuals”.

The bits of the “individuals” to be copied are read in a first half portion (through the port A) of the DPRAM, while they are written in the other half portion (through port B). Two internal registers address_R and address_W (not shown in FIG. 20) store the pointers to the portions A and B. When the CORE is in the state ADDRESS_R, it enables the reading (state READ_{—}WORD) of a whole bit-string from the first portion of the DPRAM.

As stated hereinafter, a portion of this string identifies an “individual” while the remaining portion identifies the number of copies N_copies to be made of this “individual”. If the number of copies is null, the “individuals” shall not be reproduced, thus the address address_R is incremented and a new string is read from the DPRAM. If the number of copies is non null, the “individual” is to be replicated (state REPLICATION).

If the control block CORE is in the state REPLICATION and N_copies is not null, the 16 bits used for storing the value of N_copies are reset, the “individual” is copied at the address address_W and the CORE enters the state ADDRESS_W.

By contrast, if N copies is null, as it may happen when returning from the state REPLICATION to the state ADDRESS_W, the two following cases are to be considered:

address_W<255: the selection operation is not yet completed, thus the CORE enters the state ADDRESS_R for reading another bit-string; and

address_W=255: the selection operation is ended and the state READ_RNG, which is the first state of the crossover operation, is entered.

In the state A_{DDRESS}_W the number of copies to be generated is decremented and the writing address is increased. Indeed, a copy of the current “individual” has been already carried out in the state REPLICATION and it is necessary to increase the pointer to the new location in which to write.

In the state ADDRESS_W, the CORE may interrupt the replication operation and may start the crossover operation even if in this state the number of copies N_copies is not yet null. In so doing, the CORE is capable of managing a possible exceptional situation that could be caused by the fitness calculation system. Indeed, the number of copies N_copies is obtained by rounding to an integer a decimal number, thus N_copies could exceed the number of “individuals” of a generation (128). When 128 “individuals” have been generated the replication is to be stopped.

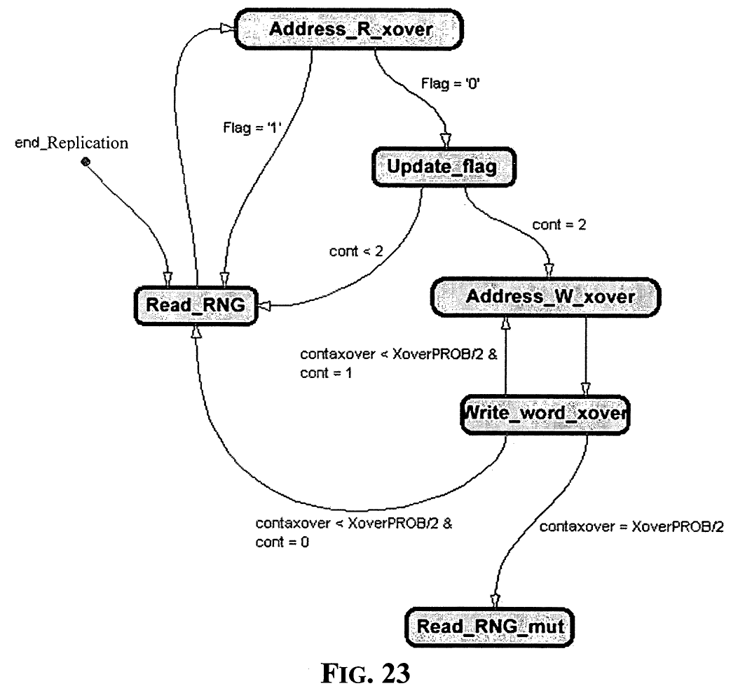

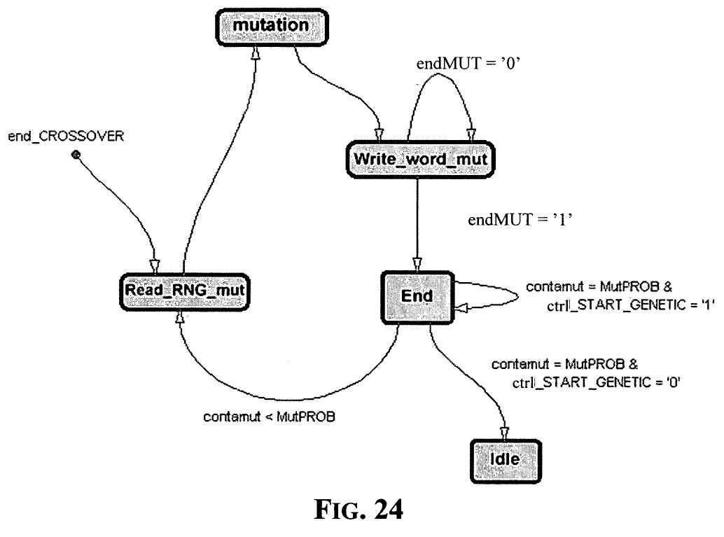

The flow chart of the steps performed by the CORE during the crossover operation is depicted in FIG. 23.

The state READ_RNG is reached when the replication, and thus the selection operation of the genetic algorithm, is over. In this state a certain number of bits (preferably 7 bits) are read from the 31-bits output register of the RNG, preferably according to the previously described circular order. Further, the DPRAM is enabled for having, at the next state, the datum read at the address just obtained from the RNG.

As highlighted above while describing the replication operation, the 16 least significant bits (that encode the number of copies) are reset, for using at least a bit FLAG whether an “individual” has been processed with the crossover operation or not.

The state ADDRESS_R_{—}XOVER is entered. In this state the CORE generates two useful addresses, that is the addresses at which “individuals” to be processed are stored:

if the internal signal FLAG of the CORE is null and the calculated address is a first address, it is stored in an internal temporary register ADDRESS_1 of the CORE and the state UPDATE_{—}FLAG is entered, or

if the signal FLAG is null and the calculated address is the second address, it is stored in a second internal temporary register ADDRESS_2 of the CORE, six bits are read from an output buffer of the random number generator RNG for generating a random crossover index P, and the state UPDATE_{—}FLAG is entered; and

if the signal FLAG is active, the “individual” has been already processed with the crossover operation, thus the state READ_RNG is entered and the output register of the RNG is read.

In the first two cases it is necessary to enable a memory write operation for updating the internal signals FLAG of each “individual”, to increment the counting CONT of an internal counter, to verify whether this counting is smaller than two (CONT<2) (because no more than two strings can be processed by XOVER block), and to prepare the signals to be input to the crossover block XOVER.

In the state UPDATE_FLAG two cases are possible:

the signal FLAG of the first “individual” stored at the first useful address is updated, thus the random number generator RNG is read again and the state READ_RNG is entered; and

the second flag is updated, thus all data to be input to the block XOVER are stored in the three internal temporary registers ADDRESS_1, ADDRESS_2 and P: in this case the signal STARTXOVER switches active and the previously described operations are carried out. When the crossover operation is over, the flag BUSY_{—}XOVER switches low. The signal for starting the block switches low and the state ADDRESS_W_{—}XOVER is entered.

In the state ADDRESS_W_{—}XOVER the CORE writes the “individuals” chrom1_out(63:0) and chrom2_out(63:0) sent by the block XOVER, in the same addresses from which they have been read in function of the value of the counting CONT. The DPRAM is enabled to write operations, the counting CONT is decremented and, if CONT=1, that is if a pair of “crossovered individuals” has been generated, a register CONTAXOVER is incremented.

Then the state WRITE_{—}WORD_{—}XOVER is entered. In this state two cases are possible: being XoverPROB the maximum number of strings that is involved in the crossover operation,

CONTAXOVER<XoverPROB/2, the number of completed crossover operations is smaller than the desired one, thus the state ADDRESS_W_{—}XOVER is entered if CONT=1 (that is another “individual” is to be written in the DPRAM), or the state READ_RNG is entered for crossovering two other “individuals”; and

CONTAXOVER=XoverPROB/2, the crossover operation is over and it is possible to start the mutation operation, which begins with the state READ_RNG_{—}MUT.

A flow chart that describes the steps to be performed by the CORE during a mutation operation is shown in FIG. 24.

When the crossover is ended (end_CROSSOVER), the CORE enters the state READ_RNG_{—}MUT for reading a pre-established number of bits (preferably 7 bit) from the 31-bits register of the RNG. As in the previous case, they are chosen according to a circular order for generating a random address ADDRESS1 of the “individual” to be subjected to the mutation operation. Further, from this register also the value of the pointer P (the crossover index) of the bit that must be switched is derived.

When the state MUTATION is entered, the “individual” to be processed chrom_MUT_IN<79:0> and the pointer to the bit to be switched column_MUT<5:0> are available. The counter of the mutations carried out CONTAMUT is to be incremented for performing a number of mutations corresponding to a pre-established mutation percentage MutPROB.

The next state WRITE_{—}WORD_{—}MUT is entered, in which the CORE waits for the flag endMUT from the block MUTATION, that signals that the mutation operation is ended. When the flag endMUT switches active, the command start_MUT switches null and the mutated “individual” chrom_MUT_OUT(79:0) generated by the block MUTATION is overwritten in the DPRAM at the same address of the “individual” that has been previously read.

Then the state END is entered. In this state the CORE compares the number of times CONTAMUT the mutation has been carried out with a desired number of mutations MutPROB to be performed. If CONTAMUT>MutPROB, the state READ_RNG_{—}MUT is entered, otherwise the signal status_END_GENETIC is switched active for signaling to the fitness calculation system (PC) that the stored data may be read again.

To prevent that the signal ctrl_START_GENETIC remains active and begins a new cycle of the genetic algorithm before the DPRAM has been read, the CORE waits that the signal CONTROL, that is forced by the fitness calculation system after having detected the leading edge of the signal status_END_GENETIC switches null. Then, also the signal status_END_GENETIC is switched low and the CORE returns into the state IDLE.

That which is claimed is:

1. A hardware device for generating an output set of bit-strings by performing crossover and mutation operations of a genetic algorithm on a current set of bit-strings, comprising:
a random or pseudo-random number generator;
a crossover block, conditioned with a random crossover index, and to which a pair of bit-strings of the current set of bit-strings are fed for generating a corresponding output pair of crossover bit-strings;
a mutation block, conditioned with a random mutation index, and to which an input bit-string to be mutated is fed for generating a corresponding bit-string of an output set of bit-strings by switching a bit of the input bit-string pointed to by the mutation index;
a memory for temporarily storing bit-strings of the current set of bit-strings and of the output set of bit-strings;
an output bus; and
a control unit, interfaced with said crossover block, said mutation block and said memory and managing their functioning by generating respective control signals, said control unit
being input with random numbers generated by said random number generator and generating the random crossover index and random mutation index, with bit-strings of the current set with their respective multiplicity,
sending the bit-strings of the current set to the crossover block together with the random crossover index,
receiving from the crossover block its output crossover bit-strings and sending them together with a respective mutation index to said mutation block, and
receiving the bit-strings of the output set generated by said mutation block, and making them available on said output bus.

2. The hardware device according to claim 1 further comprising a parallel interface controlled by said control unit, and being input with bit-strings of the current set and their respective multiplicity for transferring them to said control unit, and receiving from said control unit bit-strings of the new set.

3. The hardware device according to claim 1 wherein said pseudo-random number generator comprises:
a multiplier being input with a bit-string representing a seed or a previously generated pseudo-random number and a constant fixed bit-string, and generating a new pseudo-random bit-string including a fixed number of least significant bits of a product of the input bit-string by the constant fixed bit-string; and
a free running timer generating seeds for said multiplier at time intervals.

4. The hardware device according to claim 1 wherein said memory comprises a dual port random access memory including a first port being dedicated for receiving/sending bit-strings of the current set and a second port being dedicated for receiving/sending bit-strings of the output set.

5. A hardware device for performing crossover and mutation operations based upon a genetic algorithm comprising:
a random or pseudo-random number generator;
a crossover block, conditioned with a random crossover index, for generating output crossover bit-strings from current bit-strings;
a mutation block, conditioned with a random mutation index, for generating output bit-strings by switching at least one bit of each input bit-string pointed to by the mutation index;
a memory for temporarily storing the current bit-strings and the output bit-strings; and
a control unit, interfaced with said random number generator, said crossover block, said mutation block and said memory and managing their functioning by generating respective control signals therefor.

6. The hardware device according to claim 5 further comprising a parallel interface controlled by said control unit.

7. The hardware device according to claim 5 wherein said pseudo-random number generator comprises:
a multiplier being input with a bit-string representing a seed or a previously generated pseudo-random number and a constant fixed bit-string, and generating a new pseudo-random bit-string including a fixed number of least significant bits of a product of the input bit-string by the constant fixed bit-string; and
a free running timer generating seeds for said multiplier at time intervals.

8. The hardware device according to claim 5 wherein said memory comprises a dual port random access memory including a first port being dedicated for receiving/sending bit-strings of the current bit strings and a second port being dedicated for receiving/sending output bit-strings.

9. A proportional, integral, derivative (PID) controller comprising:
a hardware device for determining at least one PID controller gain based upon performing crossover and mutation operations based upon a genetic algorithm comprising
a random or pseudo-random number generator,
a crossover block, conditioned with a random crossover index, for generating output crossover bit-strings from current bit-strings,
a mutation block, conditioned with a random mutation index, for generating output bit-strings by switching at least one bit of each input bit-string pointed to by the mutation index,
a memory for temporarily storing the current bit-strings and the output bit-strings, and
a control unit, interfaced with said random number generator, said crossover block, said mutation block and said memory for managing their functioning by generating respective control signals therefor.

10. The PID controller according to claim 9 further comprising a parallel interface controlled by said control unit.

11. The PID controller according to claim 9 wherein said pseudo-random number generator comprises:
a multiplier being input with a bit-string representing a seed or a previously generated pseudo-random number and a constant fixed bit-string, and generating a new pseudo-random bit-string including a fixed number of least significant bits of a product of the input bit-string by the constant fixed bit-string; and
a free running timer generating seeds for said multiplier at time intervals.

12. The PID controller according to claim 9 wherein said memory comprises a dual port random access memory including a first port being dedicated for receiving/sending bit-strings of the current bit strings and a second port being dedicated for receiving/sending output bit-strings.

13. A method for performing crossover and mutation operations based upon a genetic algorithm and in a hardware device, the method comprising:
operating a random or pseudo-random number generator of the hardware device;
generating output crossover bit-strings from current bit-strings using a crossover block of the hardware device conditioned with a random crossover index;
generating output bit-strings by switching at least one bit of each input bit-string pointed to by a mutation index using a mutation block of the hardware device;
temporarily storing in a memory of the hardware device current bit-strings and the output bit-strings; and
generating respective control signals for the random number generator, the crossover block, the mutation block and the memory using a control unit of the hardware device.

14. The method according to claim 13 further comprising a parallel interface controlled by the control unit.

15. The method according to claim 13 wherein the pseudo-random number generator comprises:
a multiplier being input with a bit-string representing a seed or a previously generated pseudo-random number and a constant fixed bit-string, and generating a new pseudo-random bit-string including a fixed number of least significant bits of a product of the input bit-string by the constant fixed bit-string; and
a free running timer generating seeds for the multiplier at time intervals.

16. The method according to claim 13 wherein the memory comprises a dual port random access memory including a first port being dedicated for receiving/sending bit-strings of the current bit strings and a second port being dedicated for receiving/sending output bit-strings.
